(19) United States
(12) Patent Application Publication
(10) Pub. No.: US 2023/0297346 A1
(43) Pub. Date: Sep. 21, 2023

(54) INTELLIGENT DATA PROCESSING SYSTEM WITH METADATA GENERATION FROM ITERATIVE DATA ANALYSIS

(71) Applicant: C3.ai, Inc., Redwood City, CA (US)

(72) Inventors: David Tchankotadze, Saratoga, CA (US); Rohit Pawankumar Sureka, San Carlos, CA (US); Andrew Joseph Fitch, Redwood City, CA (US); Cherif Jazra, Palo Alto, CA (US); Edward Leslie Chayes, Palo Alto, CA (US); Manas Talukdar, Fremont, CA (US); Romain F. Juban, Half Moon Bay, CA (US); Amir Hossein Delgoshaie, Redwood City, CA (US); Shivasankaran Somasundaram, San Mateo, CA (US)

(21) Appl. No.: 18/185,210

(22) Filed: Mar. 16, 2023

Related U.S. Application Data
(60) Provisional application No. 63/269,603, filed on Mar. 18, 2022.

(51) Int. Cl. G06F 8/36; G06F 8/41

(52) U.S. Cl. CPC G06F 8/36; G06F 8/47

(57) ABSTRACT

A method includes obtaining a first data model from a data exploration phase performed in a first environment, where the first data model includes first metadata. The method also includes obtaining a second data model from the data exploration phase performed in a second environment different from the first environment, where the second data model includes second metadata. The method further includes generating a third data model including one or more software artifacts using the first metadata and the second metadata. Each of the one or more software artifacts is configured as one or more files that are configured for execution of at least one artificial intelligence (AI)/machine learning (ML) application.

This application claims priority under 35 U.S.C. § 119(e) to U.S. Provisional Patent Application No. 63/269,603 filed on Mar. 18, 2022. This provisional application is hereby incorporated by reference in its entirety.

### TECHNICAL FIELD

This disclosure is generally directed to data processing systems. More specifically, this disclosure is directed to an intelligent data processing system with metadata generation from iterative data analysis.

### BACKGROUND

Many data science tools such as Pandas are designed to solve challenges and requirements during a preliminary “data exploration” phase of a project. A goal of such tools is to provide a good interactive experience and quick turn-around of experiments on data. While such tools are adequate during the data exploration phase of a project, the “production” phase of the project usually has completely different requirements. For example, scale and performance are often key for building a software application. When the time comes to build a software application and take it into production, code written for initial data exploration with data science tools may become unsuitable for production for multiple reasons. One reason is that the code may not be designed to scale. Another reason is that the syntax and artifacts around a software application may be very different from those of data exploration.

### SUMMARY

This disclosure relates to an intelligent data processing system with metadata generation from iterative data analysis.

In a first embodiment, a method includes obtaining a first data model from a data exploration phase performed in a first environment, where the first data model includes first metadata. The method also includes obtaining a second data model from the data exploration phase performed in a second environment different from the first environment, where the second data model includes second metadata. The method further includes generating a third data model including one or more software artifacts using the first metadata and the second metadata. Each of the one or more software artifacts is configured as one or more files that are configured for execution of at least one artificial intelligence (AI)/machine learning (ML) application.

In a second embodiment, an apparatus includes at least one processing device configured to obtain a first data model from a data exploration phase performed in a first environment, where the first data model includes first metadata. The at least one processing device is also configured to obtain a second data model from the data exploration phase performed in a second environment different from the first environment, where the second data model includes second metadata. The at least one processing device is further configured to generate a third data model including one or more software artifacts using the first metadata and the second metadata. Each of the one or more software artifacts is configured as one or more files that are configured for execution of at least one AI/ML application.

In a third embodiment, a non-transitory computer readable medium contains computer readable program code that when executed causes one or more processors to obtain a first data model from a data exploration phase performed in a first environment, where the first data model includes first metadata. The non-transitory computer readable medium also contains computer readable program code that when executed causes the one or more processors to obtain a second data model from the data exploration phase performed in a second environment different from the first environment, where the second data model includes second metadata. The non-transitory computer readable medium further contains computer readable program code that when executed causes the one or more processors to generate a third data model including one or more software artifacts using the first metadata and the second metadata. Each of the one or more software artifacts is configured as one or more files that are configured for execution of at least one AI/ML application.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting intelligent data processing with metadata generation from iterative data analysis according to this disclosure;

FIG. 2 illustrates an example device supporting intelligent data processing with metadata generation from iterative data analysis according to this disclosure;

FIG. 3 illustrates an example architecture of an intelligent data processing system with a multi-interface frontend and backend according to this disclosure;

FIG. 4 illustrates an example process for generating execution engine-specific code for execution by a selected backend according to this disclosure;

FIG. 5 illustrates an example workflow for intelligent data processing with metadata generation from iterative data analysis according to this disclosure; and

FIG. 6 illustrates an example method for intelligent data processing with metadata generation from iterative data analysis according to this disclosure.

### DETAILED DESCRIPTION

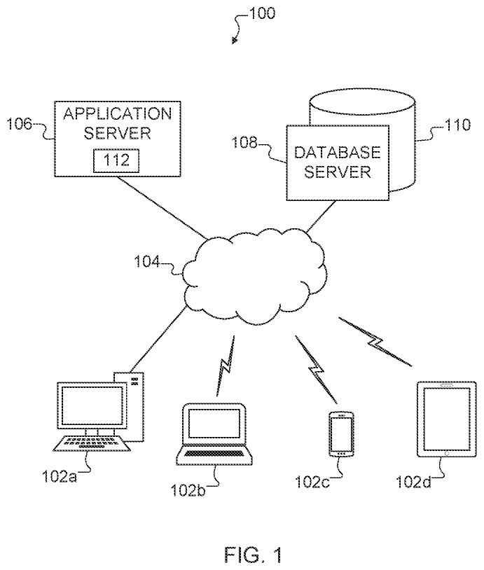

FIGS. 1 through 6, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, many data science tools such as Pandas are designed to solve challenges and requirements during a preliminary “data exploration” phase of a project. A goal of such tools is to provide a good interactive experience and quick turn-around of experiments on data. While such tools are adequate during the data exploration phase of a project, the “production” phase of the project usually has completely different requirements. For example, scale and performance are often key for building a software application. When the time comes to build a software application and take it into production, code written for initial data exploration with data science tools may become unsuitable for production for multiple reasons. One reason is that the code may not be designed to scale. Another reason is that the syntax and artifacts around a software application may be very different from those of data exploration.

Building applications that are powered by artificial intelligence (AI) or machine learning (ML) models typically involves designing multiple components that are used together, such as data exploration components, data integration components, feature store(s), ML pipeline(s), ML model(s), and the like. However, existing AI/ML tools are often characterized in that each of their components operates in a different language, and such tools usually have different (and often incompatible) hand-offs between the different components. There is typically no common thread that links all of the components together.

This disclosure provides an intelligent data processing system capable of metadata generation from iterative data analysis. As described in more detail below, the disclosed intelligent data processing system includes a multi-interface frontend and backend. For example, the data processing system can support at least one frontend (interface), which can be used by one or more users to identify data and transformations (code) to be applied to the data. Depending on the implementation, the data processing system may support the use of a single frontend or multiple frontends. The data processing system can capture the transformations and store information identifying the transformations, such as in a database. The data processing system can also use the information and a context associated with the data to perform the data processing operations. For instance, the data processing system can select a specific execution engine from among multiple execution engines (which represent multiple backends) depending on the context, and code implementing the transformations to be performed can be generated or otherwise obtained for that specific execution engine. The specific execution engine can execute the code in order to perform the data processing operations on the data. The specific context can vary based on a number of factors, examples of which are provided below. The specific execution engine that is selected for use can also vary, such as when different users or applications are associated with different contexts or when the context associated with the same user or application changes over time. Different code for performing the data transformations can be generated or otherwise obtained based on the stored information, and the different code can be executed by different execution engines. This allows the same sequence of transformations to subsequently be requested one or multiple times and performed using one or more execution engines. Moreover, the disclosed embodiments enable the building of a data model on top of an existing data model without asking a user to redo any previous work. The disclosed embodiments thus mitigate some of the drawbacks of reusing existing data transformations.

Collaborative workflow allows the intelligent data processing system to auto-generate application files (or artifacts) that are used for running production-grade enterprise-level AI/ML applications or other AI/ML applications. These artifacts can be auto-generated from data exploration work performed in any tool of choice by a user. The resulting generated artifacts are configured such that they can run at scale. Also, the data exploration work performed by a user can be in a different environment from the environment in which the application is going to be run. In addition, there is no tie-in to a particular user. That is, the auto-generation of production-grade software application artifacts can be performed by a different user than the user who initially authored the data model. The workflow also enables the composition of data models from one schema to another schema. The ability to take data models from multiple different environments and create a data model in yet another environment (considering the connectors, data sources, and systems that are related to the other data models) is advantageous.

FIG. 1 illustrates an example system 100 supporting intelligent data processing with metadata generation from iterative data analysis according to this disclosure. For example, the system 100 shown here can be used to support one or more metadata generation techniques described below. As shown in FIG. 1, the system 100 includes user devices 102a-102d, one or more networks 104, one or more application servers 106, and one or more database servers 108 associated with one or more databases 110. Each user device 102a-102d communicates over the network 104, such as via a wired or wireless connection. Each user device 102a-102d represents any suitable device or system used by at least one user to provide or receive information, such as a desktop computer, a laptop computer, a smartphone, and a tablet computer. However, any other or additional types of user devices may be used in the system 100.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations.

The application server 106 is coupled to the network 104 and is coupled to or otherwise communicates with the database server 108. The application server 106 supports techniques for intelligent data processing with metadata generation from iterative data analysis as described below. For example, the application server 106 may execute one or more applications 112 that use data from the database 110 to perform metadata generation. Note that the database server 108 may also be used within the application server 106 to store information, in which case the application server 106 may store the information itself used to perform metadata generation.

The database server 108 operates to store and facilitate retrieval of various information used, generated, or collected by the application server 106 and the user devices 102a-102d in the database 110. For example, the database server 108 may store various information related to intelligent data processing with metadata generation from iterative data analysis.

Although FIG. 1 illustrates one example of a system 100 supporting intelligent data processing with metadata generation from iterative data analysis, various changes may be made to FIG. 1. For example, the system 100 may include any number of user devices 102a-102d, networks 104, application servers 106, database servers 108, and databases 110. Also, these components may be located in any suitable locations and might be distributed over a large area. In addition, while FIG. 1 illustrates one example operational environment in which intelligent data processing with metadata generation from iterative data analysis may be used, this functionality may be used in any other suitable system.

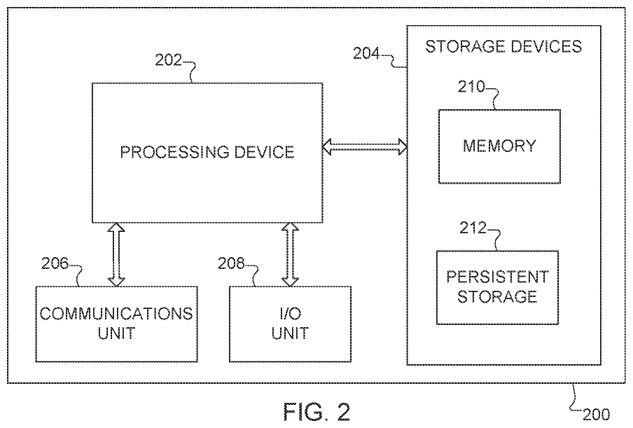

FIG. 2 illustrates an example device 200 supporting intelligent data processing with metadata generation from iterative data analysis according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application-specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

Although FIG. 2 illustrates one example of a device 200 supporting intelligent data processing with metadata generation from iterative data analysis, various changes may be made to FIG. 2. For example, computing and communication devices and systems come in a wide variety of configurations, and FIG. 2 does not limit this disclosure to any particular computing or communication device or system.

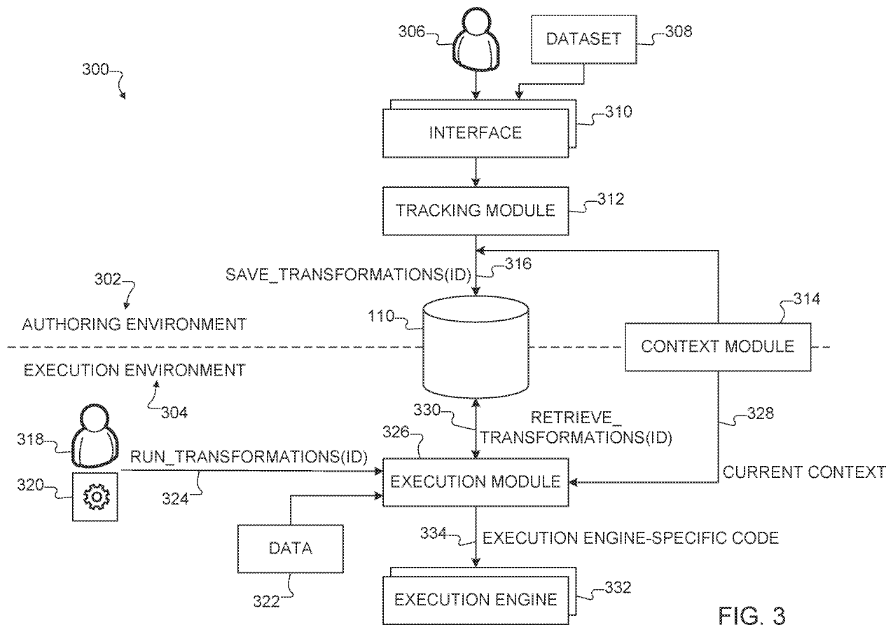

FIG. 3 illustrates an example architecture 300 of an intelligent data processing system with a multi-interface frontend and backend according to this disclosure. For ease of explanation, the architecture 300 shown in FIG. 3 is described as being implemented on or supported by the application server 106 in the system 100 shown in FIG. 1, where the application server 106 may be implemented using one or more instances of the device 200 shown in FIG. 2. However, the architecture 300 shown in FIG. 3 could be used with any other suitable device and in any other suitable system.

As shown in FIG. 3, the architecture 300 is generally divided into functions associated with an authoring environment 302 and functions associated with an execution environment 304. The authoring environment 302 generally includes functions that allow data and data transformations (code) to be defined, where information associated with the data transformations can be stored in the database 110 or other suitable storage location(s). The execution environment 304 generally includes functions that allow the code to be converted (if necessary) and executed in order to perform the data transformations upon request.

In this example embodiment, the authoring environment 302 can be used by one or more users 306 to define at least one set of data transformations to be applied to at least one input dataset 308. For example, the authoring environment 302 may include one or more interfaces 310 representing one or more frontends that are available for use. Each interface 310 can allow at least one user 306 to load a dataset 308 and define operations to be performed on the dataset 308. Note that a single interface 310 or multiple interfaces 310 may be provided in the architecture 300 depending on the implementation. Each interface 310 includes any suitable logic configured to receive data and information defining transformations to be applied to the data, such as an application programming interface (API). Specific example types of interfaces 310 that may be used here could include the Pandas API and the Structured Query Language (SQL) API.

A tracking module 312 is used in conjunction with the interface(s) 310 in order to track each sequence of transformations being applied to each dataset 308 by one or more users 306 using the interface(s) 310. In other words, the tracking module 312 can identify how each user modifies a dataset 308 using an interface 310, and the tracking module 312 can store this information in the database 110. The tracking module 312 may generate information identifying a sequence of transformations and store the information associated with each sequence of transformations in the database 110 in any suitable manner. For instance, in some cases, the tracking module 312 may generate a directed acyclic graph (DAG) that identifies each sequence of transformations applied to a dataset 308.

A context module 314 is also used within the authoring environment 302 to identify information about each context in which a user 306 is performing a sequence of transformations, and this information can also be stored in the database 110 or can be provided to the execution environment 304. Example types of information that may be identified or generated by the context module 314 are described below. In this example, the tracking module 312 and the context module 314 are shown as collectively storing data 316 associated with the sequence of transformations and optionally the context as part of a “save transformations” action. In some cases, the stored data 316 for each sequence of transformations may be associated with a user-defined identifier (ID) or other type of identification. Also, in some cases, the context module 314 may provide the context information to the tracking module 312 for storage in the database 110, the tracking module 312 may provide the sequence of transformations information to the context module 314 for storage in the database 110, or the context module 314 may provide the context information directly to the execution environment 304.

Note that the users 306 here are free to use any supported interface 310 when defining sequences of transformations to be applied to datasets 308. In some embodiments, for example, the authoring environment 302 may include one or more predefined or preinstalled interfaces 310, and the users 306 may be limited to using those specific interfaces 310. In other embodiments, one or more interfaces 310 may be installed in the authoring environment 302 as needed or desired (with or without one or more predefined or preinstalled interfaces 310 being used in the authoring environment 302). In general, the authoring environment 302 may include any suitable numbers and types of interfaces 310, regardless of how or when the interface or interfaces 310 are made available to users 306. Thus, this approach may allow different users 306 to use various interfaces 310 as needed or desired to define the sequences of transformations and other information performed on input datasets 308.

Once one or more sequences of transformations have been defined using at least one interface 310 within the authoring environment 302, each sequence of transformations can be subsequently applied within the execution environment 304. In this example embodiment, the execution environment 304 can be used to execute the sequences of transformations and process the input datasets 308 defined by the users 306 (during the first time each defined sequence of transformations is being executed). One or more users 318 and/or one or more applications 320 may also request that the same sequences of transformations be performed to their input data 322 (during subsequent executions of the sequences of transformations is being executed). The one or more users 318 represent users who wish to apply previously-defined data transformations to the input data 322, and the one or more applications 320 represent logic (executed by one or more computing devices or other devices) that requests application of previously-defined data transformations to the input data 322. Note that the one or more users 318 may or may not be the same as the one or more users 306. In this example, the application of a previously-defined data transformation may be requested using a “run transformations” request 324. In some cases, a previously-defined data transformation can be requested by including the user-defined identifier or other type of identification associated with the previously-defined data transformation in the request 324.

An execution module 326 generally operates to control the executions of the sequences of transformations for the users 306 and their input datasets 308 and the executions of the sequences of transformations for the users 318/applications 320 and their input data 322. For each sequence of transformations to be performed, the execution module 326 can receive information identifying a current context 328 associated with the data to be processed. Each current context 328 is identified using the context module 314. For example, the context module 314 can be used to identify information about the context for each user 306 as described above, and the context module 314 can be used to identify information about the context in which a user 318 or application 320 is requesting performance of a sequence of transformations for each request 324.

The context module 314 may be used to identify any suitable characteristic(s) associated with the context in which data transformations are occurring. For example, the context module 314 may determine values for different contextual dimensions associated with each sequence of data transformations. In some embodiments, examples of different contextual dimensions that may be used by the context module 314 can include any single one or any combination of the following contextual dimensions. An interactivity context dimension can represent the amount or level of user or application interactions during the processing of data in a sequence of transformations. A data size context dimension can approximate the size or amount of data to be processed during a sequence of transformations. A data type context dimension can represent the type of data to be processed during a sequence of transformations, such as real-time, batch, or streaming data. A data shape context dimension can represent whether data to be processed during a sequence of transformations is structured or unstructured and, if unstructured, a specific type of unstructured data to be processed (such as image data, video data, audio data, etc.). A security profile context dimension can represent the level of security that is needed while processing data during a sequence of transformations. A resource availability context dimension can represent the amount or level of processing resources, memory resources, or other resources that might be needed to process data during a sequence of transformations. A personal identifiable information (PII) context dimension can represent whether data to be processed during a sequence of transformations includes personal identifiable information and, if so, how that data needs to be handled. A retention policy context dimension can represent how long data being processed during a sequence of transformations or its results may need to be retained. A computation comprehensiveness context dimension can represent an overall quantity or level of data to be included in computations during a sequence of transformations. Depending on the implementation, a context may be defined along each of one or more of these context dimensions using discrete values or values that are continuous within a given range of values.

For each sequence of transformations to be performed (either for a user 306, a user 318, or an application 320), the execution module 326 can receive information identifying the current context 328 associated with the data to be processed. The execution module 326 can also obtain information about the specific sequence of transformations to be performed from the database 110, such as by retrieving information defining the sequence of transformations associated with the identifier contained in the request 324 or the sequence of transformations that was defined by the user 306. In some cases, for instance, the database 110 can be queried using a “retrieve transformations” request 330, which can be used to obtain information (such as a directed acyclic graph) associated with the sequence of transformations to be performed.

For each sequence of transformations to be performed, the execution module 326 can use at least some of the obtained information to select one of multiple execution engines 332 to be used to perform the sequence of transformations. The execution engines 332 represent different backends that can use different tools or technologies to perform requested sequences of transformations. Any suitable execution engines 332 may be used here to perform data transformations, such as backends that support different types of machine learning or artificial intelligence (ML/AI) algorithms or other data processing algorithms. In some cases, the execution module 326 may select the particular execution engine 332 to be used for each sequence of transformations to be performed based on the current context 328 of the data to be processed. As a particular example, the execution module 326 may use an in-memory data structure or other mechanism that maps different combinations of values of the contextual dimensions to different ones of the execution engines 332. Thus, the execution module 326 can take the values of a current context 328 and select the execution engine 332 that is mapped to those values.

For each sequence of transformations to be performed, the execution module 326 can further generate execution engine-specific code 334 to be executed by the selected execution engine 332. For example, the execution module 326 may traverse the directed acyclic graph associated with the sequence of transformations to be performed and modify the directed acyclic graph in a suitable manner that enables code 334 to be generated for the selected execution engine 332. Example types of modifications that may be performed to a directed acyclic graph can include removing one or more nodes from the directed acyclic graph, replacing one or more nodes in the directed acyclic graph with one or more other nodes, and/or shuffling the position(s) or order(s) of one or more nodes in the directed acyclic graph. Each node in a directed acyclic graph may generally represent a data operation to be performed as part of a sequence of transformations. The specific ways in which nodes of a directed acyclic graph are modified can vary based on a number of factors, such as the specific execution engine 332 on which the code 334 is to be executed, and no modifications may be needed to a directed acyclic graph in some cases. A modified or unmodified directed acyclic graph may be used by a compiler to generate code 334 for the selected execution engine 332. The compiler may also be used to produce execution engine-specific artifacts based on more-generic artifacts received in response to the request 330. In whatever manner the code 334 is generated, the code 334 can be executed by the selected execution engine 332 in order to perform the desired sequence of transformations.

Note that while the generation of the code 334 for the execution engines 332 is described above as being performed during run-time (such as after the users 306, 318 or applications 320 request execution of the sequences of transformations), other approaches may also be used to generate the code 334. For instance, code 334 for each execution engine 332 may be generated after data 316 associated with each sequence of transformations is obtained and stored in the database 110. In some cases, the code 334 for each execution engine 332 may also be stored in the database 110. Once a specific execution engine 332 is identified (such as in response to a specific request 324), the pre-generated code 334 for the appropriate sequence of transformations can be obtained and provided to that specific execution engine 332 for execution (without further compiling). In general, this disclosure is not limited to any particular order of request receipt and code generation.

As can be seen here, this approach allows the authoring environment 302 to be used to define any desired sequences of data transformations, where information defining the sequences of data transformations can be stored in the database 110 or other location(s) for later use. This can be accomplished using any suitable interface(s) 310 in the authoring environment 302. Also, this approach allows the execution environment 304 to be used to execute the sequences of transformations as requested, which is based (at least in part) on the information retrieved from the database 110 or other location(s). Among other things, the execution engine 332 for each sequence of transformations to be performed can be dynamically selected based on the associated context 328.

In this way, the architecture 300 is able to provide various benefits or advantages depending on the implementation. The following are non-limiting examples of various types of benefits or advantages that might be obtained using the architecture 300. For example, the architecture 300 can enable code to be developed once and then reused across different use cases (different contexts). For example, a user 306 may write code for performing a sequence of data transformations using a dataset 308 within the authoring environment 302, where that sequence of transformations is associated with one context and is used to generate code for execution by one execution engine 332. That code can later be translated by the execution module 326 for execution by any number of other execution engines 332, which can be associated with different contexts. The specific execution engine 332 selected for original use for the user 306 and the specific execution engine 332 selected for use with a subsequent request 324 can vary based on the specific contexts 328 associated with those operations. This allows the contexts and therefore the execution engines 332 used to execute the same sequence of transformations to vary based on (among other things) the changing needs of a user 306, 318 or an application 320.

As another example, the architecture 300 can be used to provide flexibility when choosing between system-driven backends and user-driven backends. For example, in some embodiments, the execution module 326 may allow users 306, 318 and/or applications 320 to select the execution engines 332 to be used to process their data. Among other things, this may allow a user 306, 318 or application 320 to select a specific execution engine 332 for use with specific data, which may be useful when the specific execution engine 332 is known to provide good results when performing specific types of data processing tasks. However, the execution module 326 can also dynamically select the execution engine 332 to be used, such as when the user 306, 318 or application 320 does not specifically identify an execution engine 332 or when the user 306, 318 or application 320 specifically requests dynamic selection of the execution engine 332.

As yet another example, the architecture 300 can be used to accelerate the time-to-value for performing data processing tasks. For example, data-intensive workloads may often involve changing backend needs over time, which would ordinarily involve time-consuming changes to an execution engine used for the data-intensive workloads. Using the architecture 300, the complexity of authoring sequences of data transformations can be reduced, and the same sequence of data transformations can be leveraged and used to execute code 334 on any number of execution engines 332 (including an execution engine 332 selected by a user 306, 318/application 320 or dynamically selected by the architecture 300). In some cases, a user 306 is able to use a single interface 310 to define a transformation, and the specific backend that is used to perform the transformation can change depending on the nature of the data processing task being performed (which can vary dynamically). This can significantly decrease the time needed to perform data processing tasks.

As still another example, the architecture 300 can be used to make server-aware and client-aware decisions when selecting execution engines 332 for use. That is, customers (users 306, 318 and/or applications 320) may implement logic using devices that operate as clients or servers depending on their particular installations. As a particular example of this, some installations may support declarative programming, while other installations may support imperative programming. Different execution engines 332 may therefore be customized for different types of customer installations. In some embodiments, the architecture 300 uses self-declarative programming, which can leverage the benefits of both declarative and imperative programming.

Note that the architecture 300 can still achieve a high level of performance when executing code using dynamically-selected execution engines 332. Among other reasons, this is because the architecture 300 can provide users 306, 318 and/or applications 320 with resource efficiencies, time efficiencies, and reliabilities when the architecture 300 chooses (and if necessary switches between) different execution engines 332 that are best suited to the needs of the users 306, 318 and/or applications 320. For example, time efficiencies can be obtained by providing good trade-offs between interactive and non-interactive contexts. In some cases, for instance, this may allow for faster outputs at lower reliability or slower outputs at higher reliability. Moreover, the architecture 300 can be used to perform data transformations on a wide range of data types, including real-time and streaming data, even when minimal resources are available to process the data. In addition, security-related aspects of the contexts for the data processing tasks can be identified and honored within the architecture 300.

Results that are generated via execution of the code 334 by the selected execution engine 332 for each sequence of transformations can be used in any suitable manner. For example, the results generated by each execution engine 332 can be provided via a suitable interface 310 or other mechanism to the user 306, 318 or application 320 that initiated performance of the sequence of transformations. Since both data processing tasks and the data being processed by the data processing tasks can vary widely, the results generated by the execution engines 332 can be used for any suitable purposes.

Although FIG. 3 illustrates one example of an architecture 300 of an intelligent data processing system with a multi-interface frontend and backend, various changes may be made to FIG. 3. For example, functions and components can be added, omitted, combined, further subdivided, replicated, or placed in any other suitable configuration in the architecture 300 according to particular needs. As a particular example, the architecture 300 may include any suitable number of interfaces 310 and any suitable number of execution engines 332.

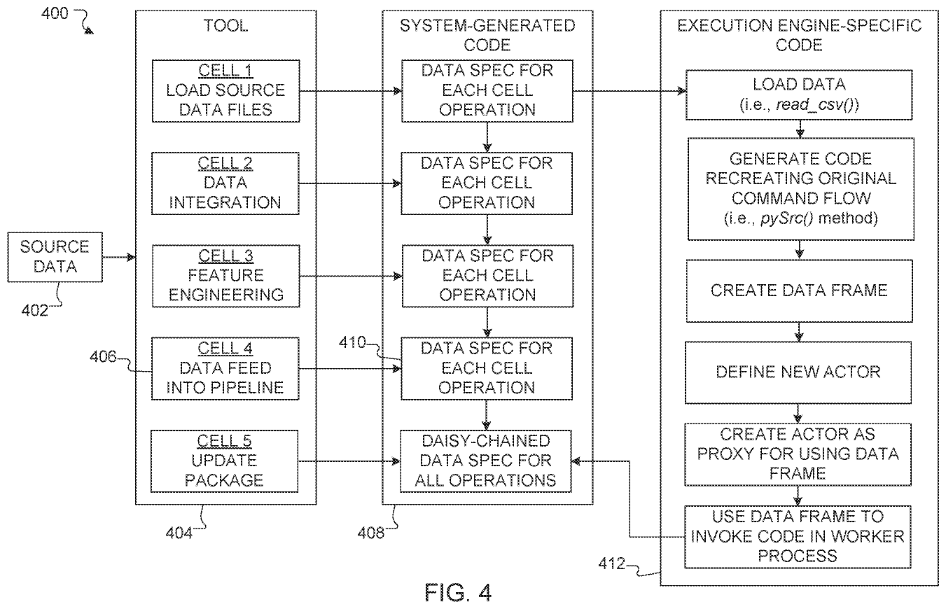

FIG. 4 illustrates an example process 400 for generating execution engine-specific code for execution by a selected backend according to this disclosure. The process 400 shown in FIG. 4 may, for example, represent the process of collecting user input via an interface 310, where the user input defines a sequence of data transformations to be performed. The process 400 shown in FIG. 4 also illustrates how the tracking module 312 can generate information about the sequence of data transformations and how the execution module 326 can use this information to produce execution engine-specific code 334 suitable for execution by a selected execution engine 332.

As shown in FIG. 4, one or more data sources 402 represent one or more interfaces (such as one or more interfaces 310) that can be used to obtain data from one or more users 306. In some embodiments, each data source 402 may be associated with a different programming language and a different data storage mechanism. Depending on the implementation, there may be a single data source 402 or multiple data sources 402 provided for use here.

Each user 306 can use one or more tools 404 to write code defining sequences of data transformations in one or more specific programming languages. In some embodiments, the tool 404 that is accessed and used by each user 306 can vary depending on which data source 402 is used by the user 306, so different data sources 402 may be associated with different tools 404. In some cases, for instance, a tool 404 may represent a JUPYTER LAB tool that uses the Pandas programming language. Of course, different tools 404 can be provided to support different programming languages if desired.

Each tool 404 here can be used to define a sequence of operations to be performed, where the sequence of operations represents a sequence of data transformations being defined by a user 306. Each operation in the sequence may be represented by a cell 406, and each cell 406 can identify at least one operation defined by the user 306. In this example, the first cell 406 represents a request to load one or more source data files. The second cell 406 represents at least one request to perform one or more data integration operations, which can include any suitable operation(s) to prepare the source data for processing. The third cell 406 represents at least one request related to feature engineering, which can include any suitable operation(s) needed to identify features of the source data that are to be processed further. The fourth cell 406 represents at least one request related to feeding the processed data (such as the identified features) into a machine learning pipeline or other data processing architecture. The fifth cell 406 represents a request to update a package that encapsulates the sequence of operations. Of course, the operations represented by the cells 406 will vary based on the specific sequence of data transformations being defined by a user 306. In some cases, the cells 406 can be digitally signed (such as by using the users' digital keys) in order to associate specific users 306 with specific cells 406 and/or to prevent unauthorized modification of the cells 406.

Each user-defined sequence of operations generated by a user 306 using a tool 404 is converted into system-generated code 408, which (when executed) can be used to perform the user-defined sequence of operations. In some cases, the system-generated code 408 can be defined using a directed acyclic graph, where the directed acyclic graph includes a number of nodes 410. Each node 410 in the directed acyclic graph represents one or more operations to be performed, and each node 410 may correspond to one of the cells 406 generated using the tool 404. For instance, each node 410 may include one or more data specifications (“data specs”) that identify the specific operation(s) performed in the corresponding cell 406. The information defined within the nodes 410 can identify the operations corresponding to every line of code generated by the user 306 using the tool 404. Thus, the nodes 410 of the directed acyclic graph may represent the logic needed to implement the user-defined sequence of operations. However, the directed acyclic graph can be generic in that it is not tied to any particular execution engine 332. As can be seen here, the nodes 410 form a directed acyclic graph since the nodes 410 are ordered in a specific sequence, which is defined by the arrows to/from/between the nodes 410. In some cases, a directed acyclic graph is at least one of the items that the tracking module 312 can generate and store in the database 110 when a user 306 uses an interface 310 to define a sequence of transformations.

After a user 306 issues a terminal transformation (meaning a final transformation defined by the user 306), the directed acyclic graph may be stored in the database 110. Also, a specific execution engine 332 can be selected as described above based on the current context associated with the user 306. In order to execute the sequence of transformations defined by the directed acyclic graph on the selected execution engine 332, the directed acyclic graph can be converted into code 412 that is suitable for execution by the selected execution engine 332. Because the directed acyclic graph generically defines operations to be performed, the directed acyclic graph can be easily converted into code 412 that is specific to the execution engine 332 on which the code 412 is to be executed. The code 412 may then be compiled or otherwise prepared and sent to the selected execution engine 332 for execution. If the same sequence of transformations is requested again (such as via a request 324) but a different execution engine 332 is selected, the directed acyclic graph can again be retrieved and used to generate code 412 for execution by that selected execution engine 332. Note that after code 412 is generated for a specific execution engine 332, the code 412 might be stored (such as in the database 110) so that the code 412 can be executed again later if requested without delay.

Note that the specific operations performed within the code 412 will typically vary depending on (among other things) the execution engine 332 to be used to execute the code 412. Because the directed acyclic graph includes data specs or other information that generically defines the operations to be performed as part of a user-defined sequence of operations, knowledge of a specific execution engine 332 can be used to generate logic that allows the execution module 326 to convert data specs into execution engine-specific code. By defining suitable logic for all available execution engines 332, the execution module 326 is able to convert directed acyclic graphs into suitable code 412 whenever executions of user-defined sequences of operations are requested.

Although FIG. 4 illustrates one example of a process 400 for generating execution engine-specific code for execution by a selected backend, various changes may be made to FIG. 4. For example, the code defined by a user may include any suitable number of operations, and these operations may be converted into any suitable operations to be executed by a selected execution engine 332. Also, the specific code 412 shown in FIG. 4 relates to a specific execution engine 332, and any other suitable code 412 may be generated depending on the execution engine 332.

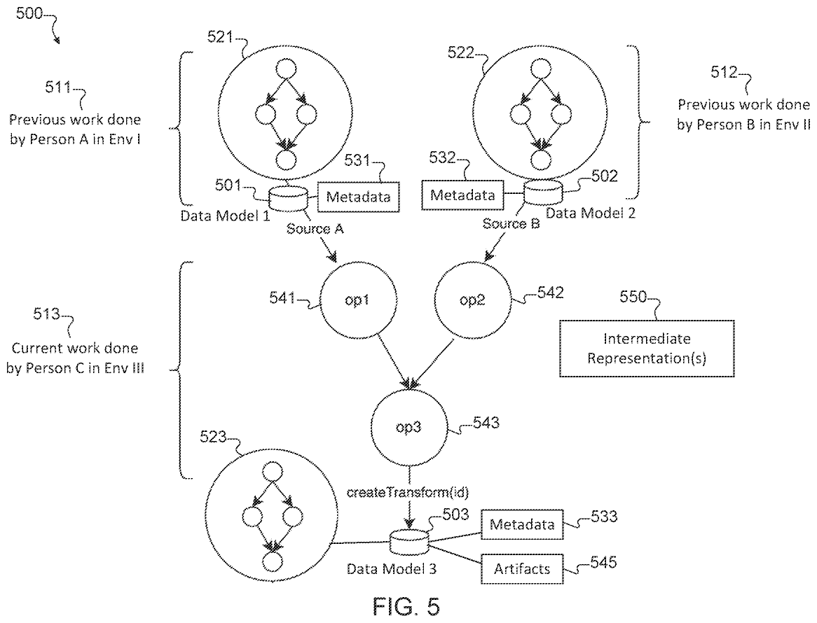

FIG. 5 illustrates an example workflow 500 for intelligent data processing with metadata generation from iterative data analysis according to this disclosure. In some embodiments, the workflow 500 may be implemented using a data modeling system or application development system (such as an intelligent data processing system having the architecture 300), which can be executed using one or more devices (such as the application server 106 or one or more of the user devices 102a-102d of FIG. 1 or one or more devices 200 of FIG. 2). However, the workflow 500 shown in FIG. 5 could be implemented using any other suitable device and in any other suitable system.

As shown in FIG. 5, using the workflow 500, various users (such as the users 306 and 318) can collectively work on one or more data models from a single interface (such as the interface 310) in an iterative manner, thereby accelerating the time to production. One or more contexts from the data exploration phase can be saved as software artifacts (such as files, code, and the like) and used for application development. Thus, some users 306, 318 can take advantage of iterative exploration performed by other users 306, 318 and generate the artifacts just by a function call. In some embodiments, at least some of the artifacts are human-readable, machine-executable, or both, which can enable continuously integrated and deployable application development. This is an advantageous benefit over conventional systems that do not generate any human-readable or machine-executable files or code.

As shown in FIG. 5, a first user 306, 318 (“Person A”) can build a data model 501 (“Data Model 1”) for a first application 320 in a first environment 511 (“Env 1”). For example, the first user 306, 318 can use the interface 310 in the authoring environment 302 to build the data model 501. A second user 306, 318 (“Person B”) can build a second data model 502 (“Data Model 2”) for a second application 320 in a second environment 512 (“Env 2”). The environments 511, 512 can represent (or be represented by) the authoring environment 302, the execution environment 304, or a combination of the these. Using the workflow 500, the system can automatically create a graph 521, 522 (such as a directed acyclic graph) for each of the data models 501, 502 and store the graphs 521, 522 (such as in the database 110). As used here, a “data model” refers to an abstract model that organizes elements of data and relationships between the elements of data.

Each data model 501, 502 includes a corresponding group of metadata 531, 532. The metadata 531, 532 describes actual data generated or used by the corresponding data model 501, 502, their types and relationships, and the source or sources from which the actual data is produced. In some embodiments, the metadata 531, 532 can additionally or alternatively include information defining data transformations needed to create one or more features or feature sets for use in a machine learning model, such as for use by one of the backends described above. Additional details regarding the use of metadata for creating or identifying features or feature sets is found in U.S. patent application Ser. No. 17/699,025 entitled “METADATA-DRIVEN FEATURE STORE FOR MACHINE LEARNING SYSTEMS” (which is hereby incorporated by reference in its entirety).

After the data models 501, 502 and the metadata 531, 532 have been developed, a third user 306, 318 (“Person C”) can operate in a third environment 513 (“Env 3”) and leverage the data models 501, 502 and the metadata 531, 532 to develop a new data model 503 (“Data Model 3”). The data model 503 includes a group of metadata 533, which is generated using the metadata 531 associated with the data model 501 and the metadata 532 associated with the data model 502. As a particular example, the third user 306, 318 may request that the system retrieve either or both of the graphs 521, 522 and the corresponding metadata 531, 532 and load the graph(s) 521, 522 and the metadata 531, 532 into a separate authoring environment 302 as requested by the third user 306, 318. In some embodiments, the system can propagate actual data (such as machine learning model features or feature sets) from the metadata 531, 532 for reuse in the data model 503. The system can also or alternatively build on the graphs 521, 522 and the metadata 531, 532 by taking part or all of each of the graphs 521, 522 and the metadata 531, 532 and combining them to generate the graph 523 and the metadata 533, which are part of or otherwise associated with the data model 503. Thus, while the data model 503 is being generated, the source of the graph 523 and the metadata 533 may not be new data but instead may be the existing graphs 521, 522 and metadata 531, 532. The existence of the graphs 521, 522 and the type of system make it possible to have the same APIs available across multiple run times and multiple environments. In this way, applications using one of the data models 501-503 in one of the environments 511-513 can use the same data model 501-503 in a different environment 511-513. Thus, the data models 501-503 themselves are compatible across different environments 511-513.

While the third user 306, 318 develops the data model 503, the third user 306, 318 can provide instructions to the system to perform one or more operations 541-543. Each operation 541-543 includes one or more definitions for one or more data transformations, which in some cases can be saved in the database 110. The one or more data transformations can be used by the system to produce a new set of artifacts 545, which can be included as part of or otherwise associated with the data model 503. Each of the artifacts 545 represents a file or code that is configured for execution by an application. The data model 503 can be executed in an execution environment 304 that is the same as or different from the execution environments 304 of the other two data models 501, 502.

To prepare the data models 501, 502 for generation of the data model 503, the system can generate an intermediate representation 550 of each of the data models 501, 502. Each intermediate representation 550 is a data structure that contains information to maintain the sequence of transformations from each data model 501, 502 that are used to create the artifacts 545 for the data model 503. Each intermediate representation 550 also includes the context in which these transformations were entered. In some embodiments, the system can perform one or more of the operations 541-543 using the intermediate representation(s) 550. Also, by using the intermediate representation(s) 550, the system can perform one or more run-time optimizations (such as vertex fusion, vertex expansion, subexpression elimination, and the like) on these transformations. The system can take the intermediate representation(s) 550 and the associated context(s) and convert them into one or more artifacts 545 for the data model 503.

In some embodiments, the system can support version control of the data models 501-503 and their generated artifacts 545 in order to support continuous iterative application development in each environment 511-513 by one or multiple users 306, 318. With each iteration that generates a new version, a version identifier can be updated to track progress. Thus, each environment 501-503 can be used for continuous iterative application development. Any suitable techniques can be used to support version control in the system. In addition, the system can refine generated artifacts 545 and hence support collaborative application development on top of the artifacts 545. For example, one user 306, 318 could write a transformation in a user-interface way and a second user 306, 318 could write the same transformation in a code-interface way, and both users can collaborate iteratively. Thus, multiple users 306, 318 who are operating in different contexts can collaborate. Most conventional data science tools (such as Pandas) support collaboration mainly at the interface level. In contrast, the workflow 500 can enable collaboration at both the interface level and the generated artifacts level. This improves the overall collaboration between the multiple users 306, 318.

Also, in some embodiments, the interface 310 used by the users 306, 318 to develop one or more of the data models 501-503 could be different than the interface 310 used to develop another one or more of the data models 501-503. That is, different data models 501-503 could be developed using different interfaces 310. In some cases, one interface 310 can include an API that is not found in another interface 310 and that is not supported in certain execution environments 304. The workflow 500 can handle such cases. For example, as the artifacts 545 are generated for the graph 523 in the environment 513, assume a node in the graph 523 describes an operation not supported by the environment 513. In that case, the workflow 500 enables the system to take the outputs of all parent nodes, move the outputs into a different environment that does support the operation, run the operation in the different environment, and bring the results back into the environment 513 to continue the process.

To summarize, the workflow 500 allows the system to auto-generate the artifacts 545, which can be used for running production-grade enterprise-level AI/ML applications or other AI/ML applications. The artifacts 545 can be auto-generated from data exploration work performed by the user(s) 306, 318 using any suitable interface(s) 310. The resulting artifacts 545 are configured such that they can run at scale. Also, the data exploration work performed by the user(s) 306, 318 can be in completely different environment(s) 511-513 from the environment(s) 511-513 in which the application is going to be executed. In addition, there is no tie-in to a particular user 306, 318, so the auto-generation of the production-grade software application artifacts 545 can be performed by different user(s) 306, 318 than the user(s) 306, 318 who initially authored the data model 501-503.

Although FIG. 5 illustrates one example of a workflow 500 for intelligent data processing with metadata generation from iterative data analysis, various changes may be made to FIG. 5. For example, functions and components can be added, omitted, combined, further subdivided, replicated, or placed in any other suitable configuration in the workflow 500 according to particular needs. As a particular example, the workflow 500 may include or be associated with any suitable number of data models, environments, users, and operations.

Note that the functions shown in or described with respect to FIG. 3 through can be implemented in an electronic device, such as a computing device, in any suitable manner. For example, in some embodiments, at least some of the functions shown in or described with respect to FIGS. 3 through 5 can be implemented or supported using one or more software applications or other software instructions that are executed by one or more processing devices of an application server 106, device 200, or other device. In other embodiments, at least some of the functions shown in or described with respect to FIGS. 3 through 5 can be implemented or supported using dedicated hardware components. In general, the functions shown in or described with respect to FIGS. 3 through 5 can be performed using any suitable hardware or any suitable combination of hardware and software/firmware instructions.

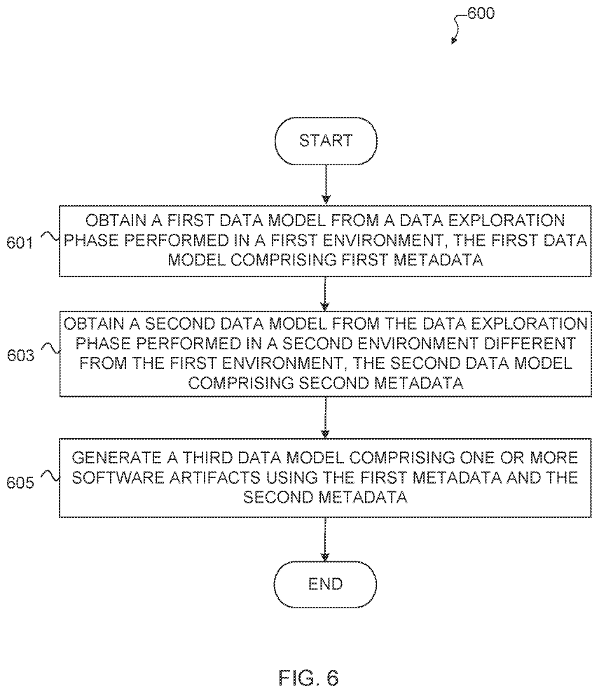

FIG. 6 illustrates an example method 600 for intelligent data processing with metadata generation from iterative data analysis according to this disclosure. For ease of explanation, the method 600 shown in FIG. 6 is described as involving the use of the application server 106 shown in FIG. 1 implemented using one or more devices 200 shown in FIG. 2 and supporting the architecture 300 shown in FIG. 3 and the workflow 500 shown in FIG. 5. However, the method 600 shown in FIG. 6 could be used with any other suitable electronic device and any other suitable architecture or workflow.

As shown in FIG. 6, a first data model is obtained from a data exploration phase performed in a first environment at step 601. The first data model includes first metadata. This could include, for example, the server 106 obtaining the data model 501 from a data exploration phase performed in the environment 511, where the data model 501 includes metadata 531. A second data model is obtained from the data exploration phase performed in a second environment different from the first environment at step 603. The second data model includes second metadata. This could include, for example, the server 106 obtaining the data model 502 from the data exploration phase performed in the environment 512, where the data model 502 includes metadata 532.

A third data model including one or more software artifacts is generated using the first metadata and the second metadata at step 605. Each of the software artifacts is configured as one or more files that are configured for execution of at least one enterprise-level AI/ML application or other AI/ML application. Third metadata associated with the third data model is also generated using the first metadata and the second metadata. This could include, for example, the server 106 generating the data model 503 using the metadata 531 and the metadata 532. The data model 503 can include one or more artifacts 545 and can also include the metadata 533.

Although FIG. 6 illustrates one example of a method 600 for intelligent data processing with metadata generation from iterative data analysis, various changes may be made to FIG. 6. For example, while shown as a series of steps, various steps in FIG. 6 could overlap, occur in parallel, occur in a different order, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining a first data model from a data exploration phase performed in a first environment, the first data model comprising first metadata;
obtaining a second data model from the data exploration phase performed in a second environment different from the first environment, the second data model comprising second metadata; and
generating a third data model comprising one or more software artifacts using the first metadata and the second metadata;
wherein each of the one or more software artifacts is configured as one or more files that are configured for execution of at least one artificial intelligence (AI)/machine learning (ML) application.

2. The method of claim 1, wherein:
generating the third data model comprises generating third metadata associated with the third data model using the first metadata and the second metadata; and
each of the first, second, and third metadata comprises information defining data transformations for creating one or more features or feature sets for use in a machine learning model.

3. The method of claim 1, wherein generating the third data model comprises:
performing one or more operations on at least one of the first data model and the second data model, the one or more operations defining one or more data transformations; and
generating the one or more software artifacts using the one or more data transformations.

4. The method of claim 3, wherein the one or more operations are performed using an intermediate representation that maintains a sequence of the one or more data transformations, the intermediate representation comprising a context associated with the one or more data transformations.

5. The method of claim 3, wherein generating the third data model further comprises combining at least a portion of a first graph associated with the first data model and at least a portion of a second graph associated with the second data model into a third graph associated with the third data model.

6. The method of claim 1, wherein generating the third data model comprises iteratively generating multiple versions of the third data model based on input from multiple users.

7. The method of claim 1, wherein the one or more files are human-readable and machine-executable.

8. An apparatus comprising:
at least one processing device configured to:
obtain a first data model from a data exploration phase performed in a first environment, the first data model comprising first metadata;
obtain a second data model from the data exploration phase performed in a second environment different from the first environment, the second data model comprising second metadata; and
generate a third data model comprising one or more software artifacts using the first metadata and the second metadata;
wherein each of the one or more software artifacts is configured as one or more files that are configured for execution of at least one artificial intelligence (AI)/machine learning (ML) application.

9. The apparatus of claim 8, wherein:
to generate the third data model, the at least one processing device is configured to generate third metadata associated with the third data model using the first metadata and the second metadata; and
each of the first, second, and third metadata comprises information defining data transformations for creating one or more features or feature sets for use in a machine learning model.

10. The apparatus of claim 8, wherein, to generate the third data model, the at least one processing device is configured to:
perform one or more operations on at least one of the first data model and the second data model, the one or more operations defining one or more data transformations; and
generate the one or more software artifacts using the one or more data transformations.

11. The apparatus of claim 10, wherein the at least one processing device is configured to perform the one or more operations using an intermediate representation that maintains a sequence of the one or more data transformations, the intermediate representation comprising a context associated with the one or more data transformations.

12. The apparatus of claim 10, wherein, to generate the third data model, the at least one processing device is further configured to combine at least a portion of a first graph associated with the first data model and at least a portion of a second graph associated with the second data model into a third graph associated with the third data model.

13. The apparatus of claim 8, wherein, to generate the third data model, the at least one processing device is configured to iteratively generate multiple versions of the third data model based on input from multiple users.

14. The apparatus of claim 8, wherein the one or more files are human-readable and machine-executable.

15. A non-transitory computer readable medium containing computer readable program code that when executed causes one or more processors to:
obtain a first data model from a data exploration phase performed in a first environment, the first data model comprising first metadata;
obtain a second data model from the data exploration phase performed in a second environment different from the first environment, the second data model comprising second metadata; and
generate a third data model comprising one or more software artifacts using the first metadata and the second metadata;
wherein each of the one or more software artifacts is configured as one or more files that are configured for execution of at least one artificial intelligence (AI)/machine learning (ML)application.

16. The non-transitory computer readable medium of claim 15, wherein:
the computer readable program code that when executed causes the one or more processors to generate the third data model comprises:
computer readable program code that when executed causes the one or more processors to generate third metadata associated with the third data model using the first metadata and the second metadata; and
each of the first, second, and third metadata comprises information defining data transformations for creating one or more features or feature sets for use in a machine learning model.

17. The non-transitory computer readable medium of claim 15, wherein the computer readable program code that when executed causes the one or more processors to generate the third data model comprises:
computer readable program code that when executed causes the one or more processors to:
perform one or more operations on at least one of the first data model and the second data model, the one or more operations defining one or more data transformations; and
generate the one or more software artifacts using the one or more data transformations.

18. The non-transitory computer readable medium of claim 17, wherein the computer readable program code when executed causes the one or more processors to perform the one or more operations using an intermediate representation that maintains a sequence of the one or more data transformations, the intermediate representation comprising a context associated with the one or more data transformations.

19. The non-transitory computer readable medium of claim 17, wherein the computer readable program code that when executed causes the one or more processors to generate the third data model further comprises:
computer readable program code that when executed causes the one or more processors to combine at least a portion of a first graph associated with the first data model and at least a portion of a second graph associated with the second data model into a third graph associated with the third data model.

20. The non-transitory computer readable medium of claim 15, wherein the computer readable program code that when executed causes the one or more processors to generate the third data model comprises:
computer readable program code that when executed causes the one or more processors to iteratively generate multiple versions of the third data model based on input from multiple users.
